(19) United States
(12) Patent Application Publication
(10) Pub. No.: US 2015/0258762 A1
(43) Pub. Date: Sep. 17, 2015

(54) Method of Producing Isotropic Random Mat for Forming Thermoplastic Composite Material

(71) Applicant: Teijin Limited, Osaka (JP)

(72) Inventors: Katsuyuki Hagihara, Matsuyama-shi (JP); Yuhei Konagai, Matsuyama-shi (JP); Naoaki Sonoda, Matsuyama-shi (JP)

(73) Assignee: Teijin Limited, Osaka (JP)

(21) Appl. No.: 14/212,230

(22) Filed: Mar. 14, 2014

(51) Int. Cl. B32B 37/15

(52) U.S. Cl. CPC B32B 37/15; B32B 2262/106

(57) ABSTRACT

There is provided a method of producing a random mat for manufacturing a thermoplastic composite material, including: slitting continuously a strand including reinforcing fibers in a longitudinal direction of the strand to form a plurality of reinforcing fiber strands with narrow width; cutting the reinforcing fiber strands with narrow width continuously to be an average fiber length of 3 mm to 100 mm to form reinforcing fiber strand pieces; spraying gas onto the cut reinforcing fiber strand pieces for opening the reinforcing fiber strand pieces to form reinforcing fiber bundle pieces; and depositing and fixing the reinforcing fiber bundle pieces onto a breathable support together with a thermoplastic resin in a powder or short fibrous form to form an isotropic random mat in which the reinforcing fibers and the thermoplastic resin are mixed.

### BACKGROUND

1. Field

The present disclosure relates to a method of producing an isotropic random mat for manufacturing a fiber-reinforced composite material which includes a thermoplastic resin as a matrix.

2. Description of Related Art

A fiber-reinforced composite material, in which carbon fibers, aramid fibers, glass fibers or the like are used as a reinforcing fiber in order to reinforce a resin, has been widely used for structural materials of aircrafts and vehicles or for molding materials in general industries or sports goods such as a fishing rod, a tennis racket and a golf shaft through utilization of its high specific strength and high specific modulus. Forms of reinforcing fibers used in the composite material may include a fabric made by using continuous reinforcing fibers, a UD sheet in which reinforcing fibers are pulled and aligned in one direction, a random sheet and a non-woven fabric, made by using cut reinforcing fibers, and the like.

In general, when the fabric made by using continuous reinforcing fibers, the UD sheet or the like is used to manufacture a fiber-reinforced composite material, there is a problem that the fabric or the UD sheet needs to be layered in a plurality of layers such that a fiber arrangement direction of each layer is at a specific crossing angle of, for example, 0/+45/−45/90, due to the anisotropy of the continuous fibers, and further to be layered in a plane symmetry in order to suppress warping of a shaped article. Moreover, since in a simple layering, problems such as interlayer peeling and delamination due to lack of adhesion strength between layers tend to occur, layering process is complicated. Further, a special operation is required at the time of layering. This is a factor for increasing the cost for manufacturing the fiber-reinforced composite material.

Meanwhile, by using an isotropic random mat in advance, attempts to obtain a relatively inexpensive fiber-reinforced composite material have been made. The random mat may be manufactured by a spray-up method (dry method) of simultaneously spraying cut reinforcing fibers together with a thermosetting resin into a mold, or another method (wet method) of adding previously cut reinforcing fibers to a slurry into which a binder resin is impregnated, and then paper-making.

Among those methods, the dry method requires a small device and thus allows the random mat to be obtained at a relatively low cost. In the dry method, a method of simultaneously cutting and spraying continuous fibers is frequently utilized, and mostly uses a rotary cutter. However, in this method, when an interval between blades is widened in order to increase a fiber length of cut fibers, the cut frequency is decreased and thus discharge of fibers from the cutter becomes discontinuous. For this reason, unevenness in fiber areal weight occurs locally on a mat. Especially, when a mat with a low fiber areal weight is formed, there is an unavoidable problem in that unevenness in thickness becomes significant and thus the surface appearance becomes poor.

Another problem of the fiber-reinforced composite material is that a long time is required for molding. In general, a shaped article of the fiber-reinforced composite material is obtained by heating and pressurizing a material called a prepreg, in which a reinforcing fiber base material is impregnated with a thermosetting resin in advance, put in an autoclave for 2 hours or more. There has recently been suggested an RTM molding method in which a reinforcing fiber base material not impregnated with a resin is set within a mold, and an uncured thermosetting resin is poured thereto. This method significantly shortens a time for molding. However, even though the RTM molding method is used, a time required for molding one shaped article is 10 minutes or more.

Therefore, a composite material in which a thermoplastic resin is used as a matrix, in place of the conventional thermosetting resin, has been spotlighted. However, the thermoplastic resin generally has a higher viscosity than the thermosetting resin, and thus has a problem in that a time for impregnating a reinforcing fiber base material with the thermoplastic resin is prolonged, and as a result, a tact time until molding is prolonged.

As a method for solving the foregoing problems, there is suggested a method called thermoplastic stamping molding (TP-SMC). This is a molding method in which chopped fibers impregnated with a thermoplastic resin in advance are heated up to a temperature not less than a melting point or a flowable temperature of the resin and are introduced into a part within a mold, and immediately the mold is closed. In the method, within the mold, the fibers and the resin are allowed to flow so as to form a product shape, followed by cooling. In the method, since the fibers impregnated with the resin in advance are used, it is possible to perform a molding in a short time of about 1 minute.

Meanwhile, methods of manufacturing a chopped fiber bundle and a molding material are disclosed in Japanese Patent Application Laid-Open No. 2009-114611 and Japanese Patent Application Laid-Open No. 2009-114612. In the disclosed methods, a molding material called an SMC or a stampable sheet is used, and this molding material makes fibers and a resin flowable within a mold by a thermoplastic stamping molding. Thus there is a problem in that it is not only difficult to manufacture a thin-walled shaped article, but also fiber orientation is disturbed at the time of molding and is difficult to control.

Also, Japanese Patent Application Laid-Open No. 2010-235779 discloses, as a means for manufacturing a thin-walled product without flow of fibers, a method of forming a thin sheet from reinforcing fibers through a paper-making method, and then impregnating the thin sheet with a resin to manufacture a prepreg. In the paper-making method, in order to disperse reinforcing fibers uniformly in a dispersion liquid, all of the reinforcing fibers in the prepreg are in a single fiber form.

The present disclosure is to solve the various problems related to the above-mentioned conventional fiber-reinforced composite material, and its main objective is to provide a producing method of a random mat for manufacturing an isotropic fiber-reinforced composite material including reinforcing fibers and a thermoplastic resin with high productivity and at low cost.

### SUMMARY

(1) A method of producing a random mat for manufacturing a thermoplastic composite material, including: slitting continuously a strand including reinforcing fibers in a longitudinal direction of the strand to form a plurality of reinforcing fiber strands with narrow width; cutting the reinforcing fiber strands with narrow width continuously to be an average fiber length of 3 mm to 100 mm to form reinforcing fiber strand pieces; spraying gas onto the cut reinforcing fiber strand pieces for opening the reinforcing fiber strand pieces to form reinforcing fiber bundle pieces; and depositing and fixing the reinforcing fiber bundle pieces onto a breathable support together with a thermoplastic resin in a powder or short fibrous form to form an isotropic random mat in which the reinforcing fibers and the thermoplastic resin are mixed.

(2) The method according to (1), wherein the strands with narrow width is 0.05 mm to 5 mm.

(3) The method according to (1) or (2), wherein the breathable support is movable.

(4) The method according to any one of (1) to (3), wherein the reinforcing fibers are carbon fibers.

(5) The method according to any one of (1) to (4), wherein the isotropic random mat including: reinforcing fiber bundles (A) having single reinforcing fibers of a critical single fiber number or more, being defined by equation (1); and at least one of reinforcing fiber bundles (B1) having single reinforcing fibers of less than the critical single fiber number and single reinforcing fibers (B2):

Critical single fiber number=600/D (1)

wherein D represents an average fiber diameter (μm) of the single reinforcing fibers.

(6) The method according to (5), wherein a ratio of the reinforcing fiber bundles (A) to a total amount of the reinforcing fibers in the isotropic random mat ranges from 20 Vol % to 99 Vol %.

(7) The method according to any one of (5) or (6), wherein the average number of fibers (N) in the reinforcing fiber bundles (A) in the isotropic random mat satisfies equation (2):

0.7×10⁴/D²<N<6×10⁴/D² (2)

wherein D represents an average fiber diameter (μm) of the single reinforcing fibers.

(8) The method according to any one of (1) to (7), wherein the reinforcing fiber strand pieces are suctioned and conveyed in a transport path, the gas is sprayed onto the reinforcing fiber strand pieces from a gas spray nozzle arranged in a way of the transport path or at a distal end of the transport path, the thermoplastic resin in the powder or short fibrous form is supplied from a way of the transport path or at the distal end of the transport path, and the breathable support is movable in a specific direction.

(9) The method according to (8), wherein the transport path includes a flexible tube, and a tapered tube is connected to a distal end of the flexible tube to spread the reinforcing fibers and the thermoplastic resin in the tapered tube.

(10) The method according to (8) or (9), wherein an outlet of the transport path, which discharges the reinforcing fibers and the thermoplastic resin is reciprocated in a horizontal direction, which is perpendicular to the specific direction, to form the isotropic random mat with a specific width, the isotropic random mat including the reinforcing fibers and the thermoplastic resin in a mixed state, on the breathable support.

(11) The method according to any one of (8) to (10), wherein the ratio of the reinforcing fiber bundles (A) to the total amount of the reinforcing fibers in the random mat and the average number (N) of fibers in the reinforcing fiber bundles are freely changed by adjusting a spraying pressure of an air flow to the cut reinforcing fiber strand pieces to manufacture the isotropic random mat with various physical properties.

(12) The method according to any one of (8) to (11), wherein a supply amount of the thermoplastic resin to the outlet of the transport path is changed with elapse of time such that a volume fraction of the reinforcing fibers in the isotropic random mat is partially varied.

(13) The method according to (3), wherein a moving speed of the breathable support and a speed of the reciprocating motion of the outlet of the transport path are changed, respectively, with elapse of time such that a fiber areal weight of the isotropic random mat is continuously varied or a thickness of the isotropic random mat is inclined.

(14) The method according to any one of (8) to (13), wherein the outlet of the transport path is reciprocated in a horizontal direction, which is perpendicular to the specific direction, and a reciprocation distance is continuously changed to manufacture the isotropic random mat in which a width of the random mat is varied along a longitudinal direction of the random mat.

According to the method of the present disclosure, a substantially isotropic random mat which is capable of providing, at low cost, a fiber-reinforced composite material excellent in the surface quality and physical properties may be efficiently manufactured at low cost, and a good thermoplastic composite material may be formed by heating and pressurizing the above random mat. The thermoplastic composite material may be molded in a very short time to obtain a desired fiber-reinforced composite shaped article. Also, according to the method of the present disclosure, the obtained fiber-reinforced composite material may be thinned and isotropic, and by molding this material, a shaped article excellent in both of the appearance and physical properties may be obtained. Thus, the composite material formed by the method of the present disclosure may be useful as a molding material for, for example, an inner plate, an outer plate, and a constructional member of vehicles, railway vehicles, and aircrafts, and further a frame or a housing of various electric products, machineries and equipment.

### BRIEF DESCRIPTION OF DRAWINGS

FIG. 1 is a schematic view illustrating an example of an apparatus for carrying out continuously the method of the present disclosure.

### DETAILED DESCRIPTION OF EXEMPLARY EMBODIMENTS

An exemplary embodiment of the present disclosure will be explained in the followings.

<Reinforcing Fiber>

Reinforcing fibers used for the method of the present disclosure may be preferably at least one kind of fibers selected from the group consisting of a carbon fiber, a P-aramid fiber and a glass fiber. They may be used alone or in combination of two or more thereof. Among them, the carbon fiber is preferred from the viewpoint of providing a composite material that is lightweight and excellent in strength. As the carbon fiber, either a PAN-based or a pitch-based carbon fiber is preferable, and an average fiber diameter thereof preferably ranges from 3 μm to 12 μm, and more preferably from 5 μm to 7 μm. As for the reinforcing fibers, fibers added with a sizing agent are mostly used. The sizing agent is preferably used in an amount of 0.01 parts to 10 parts by weight based on 100 parts by weight of the reinforcing fibers.

In a case of the carbon fiber, a yarn body (in a package) constituted by wounding a substantially twistless yarn (strand) in which 3,000 to 60,000 single fibers (monofilaments) which are typically a continuous fiber are bundled around a bobbin are generally supplied.

<Thermoplastic Resin>

In the method of the present disclosure, examples of the thermoplastic resin that is used as a matrix resin may include a vinyl chloride resin, a vinylidene chloride resin, a polyvinyl acetate resin, a polyvinyl alcohol resin, a polystyrene resin, an acrylonitrile-styrene resin (AS resin), an acrylonitrile-butadiene-styrene resin (ABS resin), an acrylic resin, a methacrylic resin, a polyethylene resin, a polypropylene resin, a polyamide 6 resin, a polyamide 11 resin, a polyamide 12 resin, a polyamide 46 resin, a polyamide 66 resin, a polyamide 610 resin, a polyacetal resin, a polycarbonate resin, a polyethylene terephthalate resin, a polyethylene naphthalate resin, a polybutylene terephthalate resin, a polyarylate resin, a polyphenylene ether resin, a polyphenylene sulfide resin, a polysulfone resin, a polyethersulfone resin, a polyetherether ketone resin, a polylactic acid resin or the like, or a copolymers thereof. These thermoplastic resins may be used alone or in combination of two or more thereof.

Among these thermoplastic resins, a resin having a melting point in a range of 180° C. to 350° C. is preferred. These thermoplastic resins, if necessary, may contain other additives such as a flame retardant, a stabilizer, an anti-UV agent, an antistatic agent, a pigment, a release agent, a softening agent, a plasticizer or a surfactant.

In the method of the present disclosure, the thermoplastic resin in a solid phase may be used, and may be present in a powder and/or a short fibrous form. In all cases, a resin of which form and size are capable to being diffused in an air flow generated by a gas spraying to be described later is used.

The thermoplastic resin in a powder form preferably includes a particle of a spherical shape or a strip shape. The spherical shape may preferably include a rotating body of a circle or an ellipse, or an egg-like shape. In a case of the spherical shape, an average particle diameter ranges preferably from 0.01 μm to 1,000 μm. The average particle diameter ranges more preferably from 0.1 μm to 900 μm, and further more preferably from 1 μm to 800 μm. There is no particular limitation on the distribution of the particle diameter, but for obtaining a thinner shaped article, a sharp distribution is more preferred. A desired particle size distribution may be adjusted by an operation such as a classification to be used. Examples of the strip shape may include, as a preferred shape, cylindrical (e.g., pellet), prismatic, flake, and scaly-piece shapes. The strip shaped material may preferably include a thermoplastic resin film cut into a small strip form. In this case, the powders may have an aspect ratio to some extent, but the length of the longest part may preferably be almost the same as that in the short fibrous form to be described later, that is, the dimension of the longest part may be 50 mm or less, and preferably 10 mm or less.

In the case that the thermoplastic resin in the short fibrous form, the fineness ranges from 100 dtex to 5,000 dtex, and more preferably from 1,000 dtex to 2,000 dtex. The average fiber length ranges preferably from 0.5 mm to 50 mm, and more preferably from 1 mm to 10 mm.

In the method of the present disclosure, as for the thermoplastic resin, a resin in a powder form and a resin in a short fibrous form may be used in combination.

When manufacturing the composite material of the present disclosure, the material may include, if necessary, various kinds of fibrous or non-fibrous fillers, or additives such as a flame retardant, a stabilizer, an anti-UV agent, an antistatic agent, a pigment, a release agent, a softening agent, a plasticizer or a surfactant within a limitation that does not impair the object of the present disclosure, in addition to the above-mentioned main raw materials.

[Manufacturing of Isotropic Random Mat for Composite Material]

Hereinafter, a preferred method of obtaining the isotropic random mat of the present disclosure and the composite material using it will be described. The method of the present disclosure includes preferably the following processes (I) to (VI). The particularly excellent isotropic random mat and the composite material are manufactured by performing these processes sequentially.

For the random mat manufactured by the method of the present disclosure, reinforcing fibers are not aligned in a specific in-plane direction, but are dispersed and arranged in random in-plane directions. That is, the random mat according to the method of the present disclosure is an in-plane isotropic material. When obtaining a shaped product from the random mat, the isotropy of the reinforcing fibers in the random mat is maintained in the shaped product. By calculating a ratio of tensile moduli in two in-plane perpendicular directions of the shaped product obtained from the random mat, the isotropy of the random mat and the shaped product thereof may be quantitatively evaluated. When a ratio obtained by dividing the larger one by the smaller one among tensile modulus values in the two perpendicular directions of the shaped product obtained from the random mat is not greater than 2, the product is considered to be in-plane isotropic. When the ratio is not greater than 1.3, the product is considered to be excellent in isotropy.

(I) Process of Supplying Reinforcing Fiber Strands

In the method of the present disclosure, from a plurality of reinforcing fiber-wound yarn bodies disposed on a creel section, respective yarns are drawn. The drawn yarns are used in a single yarn or a strand that a plurality of pulled and aligned yarns, as a reinforcing fiber. The strand width preferably ranges from 10 mm to 50 mm (particularly 20 mm to 30 mm). Therefore, when a strand width of the supplied reinforcing fibers is small, if necessary, a strand may be widened up to the above specific width in the process of supplying the strand to form a thin wide-width strand. The widening operation may be done, for example, by bringing the strand in contact with a roller or a bar for widening the width.

(II) Process of Slitting Strands

The above reinforcing fiber strand is continuously slit in parallel to a longitudinal direction of the strand (that is, along the longitudinal direction of fibers) to obtain a plurality of narrow width strands having a strand width ranging from 0.05 mm to 5 mm, preferably from 0.1 mm to 1.0 mm.

Specifically, in this process, the wide width strand continuously conveyed from the previous process may be continuously cut in a vertical direction by using a vertical slitter with blades parallel to the longitudinal direction of fibers, or the wide width strand is split into a plurality of strands with one or a plurality of split guides provided in a traveling path of the wide width strand. In the method of the present disclosure, the above described slitting of the supplied wide width strand is to adjust fiber configuration in the resulting random mat to a suitable state. In a case where the strand width is out of this range, the random mat having a specific fiber configuration to be described later may be hardly obtained, and as a result, an excellent composite material suitable for the object of the present disclosure becomes difficult to be manufactured.

(III) Process of Cutting Reinforcing Fibers

Subsequently, the above described reinforcing fiber strands slit to be a narrow width is cut to have an average fiber length of 3 mm to 100 mm, and preferably of 4 mm to 50 mm. Here, an average fiber length out of the above range is not desirable, because the linearity of the fibers is not retained and thus a molded composite material may not exhibit a sufficient strength.

Meanwhile, a so called “average fiber length” is obtained by a method in which fiber lengths of randomly extracted 100 fibers are measured by a unit of 1 mm with a vernier caliper, or the like, and the average thereof is obtained. In a usual case, the average fiber length coincides with the cut interval of the strand by a cutter.

In the method of the present disclosure, as an apparatus used for cutting the reinforcing fiber to be the average fiber length of 3 mm to 100 mm, a rotary cutter is preferred.

As for a rotary cutter, the cutter having a spiral knife with a specific angle is preferably used. When a random mat for reinforcing a thermoplastic resin, which is excellent in surface quality, is obtained, it is necessary to suppress the unevenness in a fiber areal weight. In a conventional rotary cutter, cut of the fibers is discontinuous. When the fibers are introduced into formation of the mat as it is, unevenness in the fiber areal weight is prone to occur. Therefore, the fibers may be cut continuously without breaking on their way by using a knife arranged in a specific angle, and thus a mat in which the unevenness in a fiber areal weight is reduced may be achieved. The knife angle for continuously cutting the reinforcing fibers may be calculated geometrically by the width of the reinforcing fibers to be used and the fiber length after cutting thereof, and their relationships are preferable to satisfy the condition of the following equation (a):

Fiber length of the reinforcing fiber (Pitch of blades)=reinforcing fiber strand width×tan(90-θ) (a)

in which, θ represents an angle of the disposition direction of a knife with respect to the circumferential direction.

In this case, when using a cutter that has a knife perpendicular to the longitudinal direction of fibers together with a knife parallel to the longitudinal direction of fibers, slitting fiber bundles in the vertical direction is performed simultaneously with cutting them into a certain fiber length. By using such a cutter, the slitting process (II) and the cutting process (III) can be carried out simultaneously.

(IV) Process of Opening Cut Reinforcing Fibers

In the next process, by spraying gas onto the strands (hereinafter, which may be referred to as “strand pieces”) of the reinforcing fibers cut into a specific fiber length, the above strand pieces are opened to be divided into fiber bundles having a desired size (the number of bundled filaments). In the opening process (IV) of the method of the present disclosure, the strand pieces are introduced into a path made of a flexible pipe such as a flexible tube or a hose, and a gas such as air is sprayed onto the strand pieces passing through the path such that the strand pieces are separated into a desired bundle size, and dispersed in the gas. The opening degree may be appropriately controlled by pressure of sprayed air or the like. In a preferred exemplary embodiment of the invention, the reinforcing fibers may be suitably opened by providing an air spray nozzle in the way of the path or at the distal end of the path and by spraying directly the air on the strand pieces at a wind velocity of 5 msec to 500 msec from compressed air spray holes. Specifically, the reinforcing fibers may be opened to be a desired degree by forming a plurality of holes with a diameter of about 1 mm in the path through which the reinforcing fiber pieces pass, by applying a pressure ranging from 0.2 MPa to 0.8 MPa from the outside, and by spraying directly the compressed air onto the strand pieces from gas spray nozzles provided on the holes.

In the opening process, not all fibers constituting the strand pieces are opened to be apart from each other and completely separated up to the single fiber form. Some fibers are opened to become in the single fiber form or in a form close to the single fiber form, but many fibers are adjusted such that they become fiber bundles in which a specific number or more of single fibers are bundled. That is, the opening degree by gas may be adjusted such that a ratio of reinforcing fiber bundles (A) having single reinforcing fibers of a critical single fiber number or more, the critical single fiber number being defined by the following equation (1), to the total amount of the reinforcing fibers in the random mat to be described later ranges from 20 Vol % to 99 Vol %, preferably from 30 Vol % to 90 Vol %, and more preferably from 30 Vol % to 80 Vol %. Further, it is preferable that the average number of fibers (N) in the reinforcing fiber bundles (A) having the single reinforcing fibers of the critical single fiber number or more satisfies the following equation (2).

Critical single fiber number=600/D (1)

0.7×10⁴/D²<N<6×10⁴/D² (2)

(in which, D represents an average fiber diameter (μm) of the single reinforcing fibers)

Specifically, when the average fiber diameter of the reinforcing fibers that constitute the random mat ranges from 5 μm to 7 μm, the critical single fiber number ranges from 86 to 120, and when the average fiber diameter of the reinforcing fibers is 5 μm, the average number of fibers (N) in the reinforcing fiber bundles (A) ranges from 280 to 2,000, and preferably ranges from 600 to 1,600. When the average fiber diameter of the reinforcing fibers is 7 μm, the average number of fibers (N) in the reinforcing fiber bundles (A) ranges from 142 to 1,020, and preferably ranges from 300 to 800.

Thus, in the opening process, by controlling the opening degree in consideration of the above described conditions in slitting, cutting, and the like, at a step of forming the random mat, the mat includes the reinforcing fiber bundles (A) in which a specific number or more of reinforcing fibers are bundled in the above mentioned ratio, and the rest includes fiber bundles (B1) having single reinforcing fibers of less than the critical single fiber number and fibers (B2) completely separated to be in the single fiber form.

(V) Process of Forming Random Mat from Reinforcing fibers and Thermoplastic Resin

In this process, the cut and opened reinforcing fibers are spread in the air and at the Preferably, the reinforcing fibers may be fixed by suctioning the air from the bottom of the breathable support. The thermoplastic resin sprayed simultaneously with the reinforcing fibers may be also mixed and fixed by air suction in a case of fibrous form, or in a case of particulate form, the thermoplastic resin may be fixed in association with the reinforcing fibers.

By suctioning from a lower portion of the deposited surface in this manner, a mat having a high two-dimensional orientation can be obtained. In addition, the thermoplastic resin particles or the like may be suctioned by using negative pressure generated herein and may be mixed easily with the reinforcing fibers by the diffusion flow generated in the tube. In the obtained random mat, the thermoplastic resin particles or the like are present uniformly in the gap or the vicinity of the reinforcing fibers included in the random mat, and thus, moving distance of the resin is shorter in the heating, impregnating and pressurizing processes to be described later, and the resin is possible to impregnate in the random mat within a relatively short time.

On the other hand, in the case that apertures of a sheet or a net included in the breathable support is large and a part of the thermoplastic resin particles or the like pass through the support and are not left on the mat, in order to prevent this, a non-woven fabric may be set on the surface of the support such that the reinforcing fibers and the thermoplastic resin particles or the like may be sprayed and fixed on the nonwoven fabric. In this case, when the nonwoven fabric is constituted by the same resin as the thermoplastic resin particles or the like, it is not necessary to peel off the nonwoven fabric from the deposited mat, and by heating and pressurizing the nonwoven fabric in the following process as it is, the fibers that constitute the nonwoven fabric may also be used as a part of the thermoplastic resin to become a matrix of the composite material.

In the method of the present disclosure, the reinforcing fiber strands may be cut into a specific length, and then the strand pieces and the reinforcing fibers separated in a state of the single fiber from when being cut may be supplied into the transport path so as to suction and convey the fibers. From the gas spray nozzles provided in the way of the transport path or in the distal end of the transport path, the gas is sprayed onto the reinforcing fibers, and the cut strand pieces are separated and opened to the reinforcing fiber bundles of the desired size (thickness). At the same time, the reinforcing fibers may be sprayed together with the thermoplastic resin particles or the like, on the surface of the breathable support (hereinafter, which may be referred to as “fixing net”) which moves continuously or intermittently in a same time, the thermoplastic resin in the powder or short fibrous form (hereinafter, referred generically to “thermoplastic resin particles or the like”) is supplied such that the reinforcing fibers are sprayed onto a breathable support provided below an opening device together with the thermoplastic resin particles or the like. Thus, the reinforcing fibers and the thermoplastic resin particles or the like are mixed on the support, and deposited and fixed to be a specific thickness so as to form a random mat.

In this process, by spraying the reinforcing fibers opened by gas and at the same time the thermoplastic resin particles or the like supplied from another path onto the breathable support, the fibers and the resin are deposited on the breathable support as a mat and fixed in a state where both are almost uniformly mixed. When the breathable support is provided as a conveyor constituted by a net, and is continuously moved in one direction to allow the fibers and the resin to be deposited thereon, a random mat may be continuously formed. Also, by moving the support in all directions, uniform deposition may be achieved.

Here, the reinforcing fibers and the thermoplastic resin particles or the like are preferably sprayed to be two-dimensionally oriented. In order that the opened reinforcing fibers are applied to be two-dimensionally oriented, a tapered tube such as a cone enlarged downward is preferably used. Within the tapered tube, the gas sprayed on the reinforcing fibers is diffused, and thus flow rate within the tube is decreased while a rotational force is imparted to the reinforcing fibers. By using this Venturi effect, the opened reinforcing fibers may be evenly and spotlessly sprayed together with the thermoplastic resin particles or the like. Further, for the fixing process to be described later, the fibers and the thermoplastic resin particles or the like are preferably sprayed on a movable breathable support (net conveyor, or the like) having a suction apparatus below the support and deposited in a random mat form.

In this process, the supply amount of the thermoplastic resin particles or the like preferably ranges from 50 parts to 1,000 parts by weight based on 100 parts by weight of the reinforcing fibers. The amount of the thermoplastic resin particles or the like more preferably ranges from 55 parts to 500 parts by weight, and further more preferably from 60 parts to 300 parts by weight, based on 100 parts by weight of the reinforcing fibers.

The process of forming a random mat includes the process of fixing the reinforcing fibers and the thermoplastic resin particles or the like. That is, this fixing process is to fix the deposited reinforcing fibers and the deposited thermoplastic resin particles or the like. certain direction to be deposited and fixed. As a result, a random mat can be formed. The above mentioned transport path may preferably include a flexible pipe such as a flexible tube or a hose and a tapered tube connected to the distal end thereof. In this case, a gas spray nozzle may be provided in the connection portion of the flexible pipe and the tapered tube, and even in this case, the supplying path of the thermoplastic resin particles or the like is desirable to be formed on the inner wall of the taper tube.

In the method of the present disclosure, in order to obtain a desired random mat, the following methods may be employed, and these methods may be used in combination of two or more.

The methods include:

A) The method of producing a random mat on a fixing net by allowing distal end (e.g., the distal end of said tapered tube) of the transport path of the reinforcing fibers to be reciprocated in a horizontal direction, which is perpendicular to a certain direction in which the fixing net runs continuously;

B) The method of producing a random mat whose physical properties are varied by changing the spraying pressure of the gas with elapse of time or positionally to freely change the ratio of the reinforcing fiber bundles (A) based on the total amount of the reinforcing fibers in the random mat and the average number of fibers in the reinforcing fiber bundles (A);

C) The method of producing a random mat in which the volume fraction of the reinforcing fibers is continuously changed by supplying the thermoplastic resin particles or the like at the same time when fixing the reinforcing fibers, on the fixing net which runs in order to mix the fibers and the resin, and at that time, changing continuously the supply amount of the thermoplastic resin;

D) The method of producing a random mat in which the thickness of the material is inclined by changing the running speed of the fixing net which runs and the reciprocating motion speed of the spray nozzle, respectively, to continuously change a fiber areal weight of a material arbitrarily, when producing a random mat on the fixing net by allowing the distal end of the transport path of the reinforcing fibers to be reciprocated in the horizontally direction, which is perpendicular to the running direction of the fixing net; and

E) The method of producing a random mat in which the dimension in the width direction is varied by changing continuously the reciprocal movement distance of the spray nozzle, when producing a random mat on the fixing net by moving reciprocally horizontally the distal end of the transport path of the reinforcing fibers in the direction perpendicular to the running direction of the fixing net.

In the method of the present disclosure, when forming the random mat, if necessary, fibrous or non-fibrous fillers or various kinds of additives may be sprayed and deposited together with the reinforcing fibers and the thermoplastic resin. In addition, after depositing, a thermoplastic film may be even more layered.

<Random Mat Obtained by Method of the Present Disclosure>

In the method of the present disclosure, an isotropic random mat is formed on the breathable support (fixing net) as described above, and the random mat has preferably the following fiber configuration.

That is, the random mat of the present disclosure includes the reinforcing fibers with a fiber length of 10 mm to 100 mm and the thermoplastic resin, and the reinforcing fibers have a fiber areal weight of 25 g/m² to 3,000 g/m² and are substantially two-dimensionally randomly oriented.

In the random mat, as described above, a ratio of reinforcing fiber bundles (A) having single reinforcing fibers of the critical single fiber number or more, being defined by the following equation (1), to the total amount of the reinforcing fibers in the mat, ranges from 20 Vol % to 99 Vol %, in particular from 30 Vol % to 90 Vol %, and an average number of fibers (N) in the reinforcing fiber bundles (A) preferably satisfies following equation (2):

Critical single fiber number=600/D (1)

0.7×10⁴/D²<N<6×10⁴/D² (2)

wherein, D represents an average fiber diameter (μm) of the single reinforcing fibers.

If the ratio of the reinforcing fiber bundles (A) to the total amount of the reinforcing fibers in the random mat is less than 20 Vol %, when molding the random mat, it is advantageous that the composite material excellent in surface quality can be obtained, but the fiber-reinforced composite material excellent in mechanical properties are hardly obtained. If the ratio of the reinforcing fiber bundles (A) is greater than 99 Vol %, the fiber entangled portions become locally thicker, and thus the thin-walled one cannot be obtained, which is not suitable for an objective of the present disclosure. The ratio of the reinforcing fiber bundles (A) more preferably ranges from 30 Vol % to 90 Vol %, and still more preferably from 30 Vol % to 80 Vol %. Specifically, when the average fiber diameter of the reinforcing fibers included in the random mat ranges from 5 μm to 7 μm, the critical single fiber number ranges from 86 to 120, and the reinforcing fiber strand pieces in which the single reinforcing fibers of the critical single fiber number or more are bundled to be integrated correspond to the so called reinforcing fiber bundles (A). Thus, the suitable random mat includes the reinforcing fiber bundles (A) in which single reinforcing fibers of the critical single fiber number or more are bundled in a ratio of 20 to 99 Vol % to the reinforcing fibers included in the random mat, and the rest is the reinforcing fiber bundles (B1) having the single reinforcing fibers of less than the critical single fiber number and/or reinforcing fibers completely separated to be single fibers (B2).

In addition, the average number of fibers (N) in the reinforcing fiber bundles (A) having the single reinforcing fibers of the critical single fiber number or more preferably satisfies the following equation (2):

0.7×10⁴/D²<N<6×10⁴/D² (2)

wherein D represents an average fiber diameter (μm) of the single reinforcing fibers)

For example, when the average fiber diameter of the reinforcing fibers is 5 μm, the average number of fibers (N) in the reinforcing fiber bundles (A) ranges from 280 to 2,000, and preferably ranges from 600 to 1,600. When the average fiber diameter of the reinforcing fibers is 7 μm, the average number of fibers (N) in the reinforcing fiber bundles (A) ranges from 142 to 1,020, and preferably ranges from 300 to 800. In addition, in the random mat, the average fiber length of the reinforcing fibers ranges from 5 mm to 100 mm, preferably from 10 mm to 100 mm, more preferably from 15 mm to 80 mm, and further more preferably from 20 mm to 60 mm. In the above-mentioned cutting process of the reinforcing fiber strand, when the reinforcing fiber strand is cut to be a fixed length, the average fiber length in the random mat becomes almost the same as the cut fiber length.

When the average number of fibers (N) in the reinforcing fiber bundles (A) is 0.7×10⁴/D² or less, it is difficult to obtain a high volume fraction (Vf) of fibers. In addition, when the average number of fibers (N) in the reinforcing fiber bundles (A) is 6×10⁴/D² or more, a locally thicker portion may occur, and the portion tends to cause voids. In order to obtain a thin-walled composite material with the thickness of 1 mm or less, in a case where the fibers which are simply separated are used, the unevenness in fiber density is high, and thus the good physical properties cannot be obtained. When all fibers are opened to be the single fiber form, it becomes easier to obtain a thinner material, but entanglements of the fibers in the mat are increased, and thus the material having a high volume fraction of fibers cannot be obtained. In a random mat, the reinforcing fiber bundles (A) having the single reinforcing fibers of the critical single fiber number or more, being defined by the equation (1), and a reinforcing fiber group which includes the reinforcing fiber bundles (B1) having the single reinforcing fiber of less than the critical single fiber number and/or the reinforcing fibers (B2) completely separated to be the single fiber form may be simultaneously present in the above ratio, and thus the random mat capable of providing a thin-walled composite material with high physical properties can be obtained. This random mat may have various thicknesses, and may be used as a preform to obtain suitably a thin-walled shaped article with a thickness of approximately 0.2 mm to 1 mm. Meanwhile, the average number of fibers in the reinforcing fiber bundles (A) and a ratio of the reinforcing fiber bundles (A) can be controlled by selecting conditions in the slitting process, the cutting process, and the opening process.

As described above, the reinforcing fibers which have different bundling states may be mixed in the random mat in a specific ratio so that the surface property, physical property, formability, and the like, of the composite material may be greatly improved.

The thickness of the random mat is not specifically limited, as desired, the thickness of 1 mm to 100 mm can be obtained. On the other hand, in order to exert the effect of the present disclosure that a thin-walled shaped article of the composite material may be obtained, the random mat may preferably have the thickness of 2 mm to 50 mm.

In order that a content ratio of the reinforcing fiber bundles (A) in the random mat ranges from 20 Vol % to 90 Vol %, for example, the pressure or the like of air ejected in an opening process may be controlled. Also, the size of fiber bundles, such as the bundle width and the number of fibers per width, to be subjected to a cutting process may be adjusted to control the content ratio of the reinforcing fiber bundles (A). Specifically, there is a method of widening the width of strands and subjecting the widened thin strands to the cutting process, or a method of providing a slit process before the cutting process. Otherwise, there is a method of cutting fiber bundles by using a so-called fiber separating knife having a plurality of arranged short blades, or a method of simultaneously performing cut and slit.

The average number of fibers (N) in the reinforcing fiber bundles (A) having the single reinforcing fibers of the critical single fiber number or more is preferably less than 6×10⁴/D². In order that the average number of fibers (N) in the reinforcing fiber bundles (A) is within the foregoing range, in the following preferred manufacturing method, the size of fiber bundles, such as the bundle width and the number of fibers per width, to be subjected to a cutting process may be adjusted. Specifically, there may be a method of widening the width of fiber bundles through opening or the like and subjecting the widened fiber bundles to the cutting process, or a method of providing a slit process before the cutting process. Otherwise, the fiber bundles may be cut and slit at the same time. Also, the average number of fibers (N) in the reinforcing fiber bundles (A) may be controlled to be in a desired range by adjusting the opening degree of the cut fiber bundles through controlling the pressure or the like of gas sprayed on the fiber bundle pieces in the opening process.

In the method of the present disclosure, the random mat may be produced according to a thickness of the shaped article of the composite material for various purposes. In particular, a thin-walled mat may be useful as a preform of the thin-walled shaped article such as an outer skin of the sandwich material.

(VI) Process of Impregnating Thermoplastic Resin over Random Mat

The random mat in the present disclosure includes a solid thermoplastic resin, and becomes a preform for obtaining a fiber-reinforced composite material. In the random mat, the reinforcing fibers and the solid thermoplastic resin particles are mixed spotlessly. Specifically, the solid thermoplastic resin is present to be dispersed in the gap or the vicinity of the reinforcing fibers that constitute the random mat, and thus the fibers and the resins do not need to be flowed in the mold. For example, only when the obtained random mat passes between a pair or plural pairs of heating rollers to be heated and pressurized such that temperature of the heating rollers is set to be not less than the softening point of the thermoplastic resin, preferably the melting point, the thermoplastic resin is softened or molten, and almost uniformly impregnated in the random mat. Therefore, by rapidly cooling the random mat after the heating and pressurizing, an intended sheet-like composite material can be obtained.

On the other hand, before performing the above-described heating and pressurizing, the random mat may be preheated by being introduced continuously into the heating chamber. The preheating temperature in this case is preferably in a range from about a glass transition temperature to the melting point, of the thermoplastic resin. By performing the preheating process, the thermoplastic resin particles or the like in the random mat are partially adhered to the reinforcing fibers and fixed in the mat.

According to the present disclosure, the bundling state of the reinforcing fibers in the obtained composite material is confirmed not to be changed from the state as in the random mat. That is, when a random mat satisfies the condition of the above equations (1) and (2), a composite material in which the reinforcing fibers are impregnated with the resin also satisfies the condition of the above equations (1) and (2).

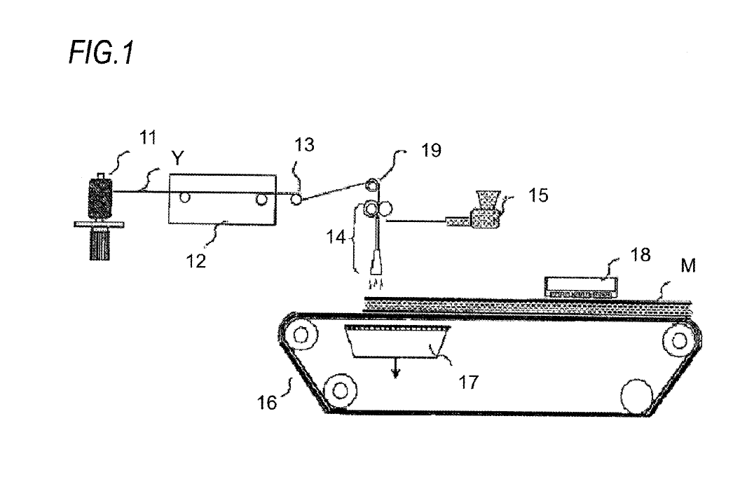

Subsequently, an example of the efficiently manufacturing the composite material by continuously performing each of the above processes is illustrated in FIG. 1. In FIG. 1, the numeral 11 represents a creel of the reinforcing fiber yarns, the numeral 12 represents a widening device for the reinforcing fiber strands arranged according to the necessity, the numeral 13 represents a fiber leading guide, the numeral 14 represents a cutting and opening device having a tapered tube at the bottom, the numeral 15 represents a supplying unit of the thermoplastic resin, the numeral 16 represents a movable breathable support (fixing net conveyor) provided below the opening device, the numeral 17 represents a suction device provided below the breathable support, the numeral 18 represents a preheating apparatus of the random mat, and the numeral 19 represents a vertical slit device (slitter) respectively. In addition, Y represents reinforcing fiber strands, and M represents a random mat.

In this example, the reinforcing fibers such as carbon fibers are drawn at a specific speed from each of the wound yarn bodies disposed on the creel 11, and supplied to the widening device 12 as a strip-like strand Y. The strand in the widening device 12 is widened to be a specific width and to be a wide and thin strip-like strands. On the other hand, when the original strand has width and thinness sufficient for slitting, they do not need to be widened. The strip-like strands subsequently pass through the fiber leading guide 13, supplied to the next process, and slit along the longitudinal direction of the strand with the vertical slit device 19 into a plurality of strands with a narrow width. Then, they are introduced into the cutting and opening device 14, cut to a specific length by a cutter provided in the device 14, and at the same time, from the air nozzles (not illustrated) provided near an inlet of the tapered tube in the conveyance path at the bottom within the device, the gas is injected toward the strand pieces in the tube, and thus the reinforcing fibers that constitute the strands are spread in the gas in a bundled state of the desired size. At this time, from the supplying unit 15 of the thermoplastic resin, the thermoplastic resin in the powder or short fibrous form is simultaneously supplied into the tapered tube, and deposited on a breathable support, specifically on the conveyor 16 provided with a breathable net, together with the reinforcing fibers. Then, the reinforcing fibers and the thermoplastic resin which are mixed with each other are deposited on the support to form a random mat by the suction device 17 disposed below the support.

When manufacturing continuously the composite material from this random mat M, the random mat M may be supplied to the heating and pressurizing apparatus (not illustrated) provided with a pair of heating rollers, and may be heated and pressurized at a temperature not less than the softening point of the thermoplastic resin, preferably of the melting point, and thus the thermoplastic resin dispersed in the random mat may be softened or molten to be uniformly impregnated over the random mat. At this time, before the heating and pressurizing, if necessary, the random mat may be preferably introduced into the preheating device provided with a heating chamber, and may be preheated to a temperature not less than the secondary transition point (Tg) of the thermoplastic resin. After heating and pressurizing, it is preferable to bring the random mat in contact with the cooling roller (not illustrated) so that the random mat is rapidly cooled near to the room temperature. Thus, a composite material sheet manufactured continuously may be cut to be a desired size by the cutting device (not illustrated), and the intended fiber-reinforced composite material (C) may be obtained. On the other hand, when a molding is performed after the manufacturing process of the composite material, the composite material with a continuous length may be preferably supplied to a molding process as it is without cutting.

<Fiber-Reinforced Composite Material Obtained from Random Mat>

From the random mat by the method of the present disclosure, the fiber-reinforced composite material including the reinforcing fibers and the thermoplastic resin can be produced by a simple operation. As described above, in the random mat of the present disclosure, the reinforcing fibers and the thermoplastic resin in a powder and/or fibrous form are present in a spotlessly mixed state. Thus, the fibers and the resin do not need to be flowed in the mold and it is advantageous that the thermoplastic resin is prone to be impregnated. Thus, the reinforcing fiber isotropy in the random mat may also be maintained in the composite material obtained by the present disclosure.

This suitable fiber-reinforced composite material substantially includes the reinforcing fibers with the above described fiber length and the thermoplastic resin. In the composite material, the reinforcing fibers are substantially two-dimensionally randomly oriented, in which in the reinforcing fiber bundles (A) having the single reinforcing fibers of the critical single fiber number or more, the critical single fiber number being defined by the following equation (1), the ratio of the reinforcing fiber bundles (A) to the total amount of the reinforcing fibers ranges from 20 Vol % to 99 Vol %, and an average number of fibers (N) in the reinforcing fiber bundles (A) satisfies the following equation (2):

Critical single fiber number=600/D (1)

0.7×10⁴/D²<N<6×10⁴/D² (2)

wherein D represents an average fiber diameter (μm) of the single reinforcing fibers.

<Use of Fiber-Reinforced Composite Material>

The random mat obtained by the method of the present disclosure or the composite material obtained therefrom can be molded into a desired shaped article by a press molding, heat molding or the like. This composite material can be molded within a very short time (e.g., within a few minutes) even when any molding method is utilized. Moreover, the obtained shaped article is lightweight and has good physical properties, and thus is very advantageous in an industrial use. Specifically, the composite material may be useful as a molding material such as an inner plate, an outer plate, and constructional elements of an automobile, a railway vehicle, and an aircraft, and further a frame or a housing of various electric products and machinery. For example, by using a carbon fiber composite material obtained by the method of the present disclosure as a skeleton, the skeleton of the electric vehicle may be manufactured within a short time of about 1 minute or less by press molding.

### EXAMPLES

Hereinafter, the present disclosure will be described with reference to Examples, but the present disclosure is not limited thereto. Meanwhile, each measurement value in Examples is measured by the following methods.

1) Analysis of Reinforcing Fiber Bundles in Random Mat

A random mat is cut into a size of about 100 mm×100 mm. From the cut mat, all of fiber bundles are extracted by tweezers, the number of bundles (I) of reinforcing fiber bundles (A), and the length (Li) and the weight (Wi) of the fiber bundles are measured and recorded. Some fiber bundles which are too small to be extracted by tweezers are lastly weighed in a mass (Wk). For the measurement of the weight, a balance capable of measuring by 1/100 mg is used. Based on the fiber diameter (D) of reinforcing fibers used for the random mat, a critical single fiber number is calculated, by which reinforcing fiber bundles (A) having the single reinforcing fiber of the critical single fiber number or more and others are separated from each other. Also, when two or more kinds of reinforcing fibers are used in combination, the fibers are divided into respective kinds, and the respective kinds of fibers are separately measured and evaluated. The method of obtaining the average number of fibers (N) of the reinforcing fiber bundles (A) will be described as follows.

The number of fibers (Ni) in the reinforcing fiber bundles (A) may be obtained from the fineness (F) of the reinforcing fibers in use by the following equation.

Ni=Wi/(Li×F)

The average number of fibers (N) in the reinforcing fiber bundles (A) may be obtained from the number of bundles (I) of the reinforcing fiber bundles (A) by the following equation.

N=ΣNi/I

The ratio (VR) of the reinforcing fiber bundles (A) to the total amount of the reinforcing fibers in the mat may be obtained by the following equation by using the density (p) of the reinforcing fibers.

VR=Σ(Wi/ρ)×100/((Wk+ΣWi)/ρ)

2) Analysis of Average Fiber Length of Reinforcing Fibers Included Over Random Mat or Composite Material

The lengths of 100 reinforcing fibers randomly extracted from the random mat or the composite material are measured by a unit of 1 mm with a vernier caliper or a loupe and recorded. From all of the measured lengths (Li) of the reinforcing fibers, the average fiber length (La) is obtained by the following equation. In a case of the composite material, after the resin is removed within a furnace at 500° C. for about 1 hour, the reinforcing fibers are extracted.

La=ΣLi/100

3) Analysis of Reinforcing Fiber Bundles in Composite Material

In the composite material, after the resin is removed within a furnace at 500° C. for about 1 hour, measurement is performed in the same manner as in the foregoing random mat.

4) Analysis of Fiber Orientation in Composite Material

In a method of measuring isotropy of fibers in the composite material after the molding of the composite material, a tension test is performed to measure tensile moduli in an arbitrary in-plane direction of a molded plate and an in-plane perpendicular direction thereto, and then among the measured values of the tensile modulus, a ratio (Eδ) obtained by dividing the larger one by the smaller one is calculated. When the ratio of the modulus is closer to 1, the material is more excellent in isotropy. In the present disclosure, when the ratio of the modulus is 1.3 or less, the material is evaluated to have isotropy.

### Example 1

As the reinforcing fiber, carbon fibers “TENAX” (trademark) STS40-24KS (average fiber diameter: 7 μm, strand width: 10 mm) manufactured by TOHO TENAX Co., Ltd were used. The fibers were slit with a width of 0.8 mm by using a vertical slit device and then cut into a fiber length of 20 mm. As for a cut device, a rotary cutter was used in which spiral knives made of cemented carbide were arranged on the surface.

Here, the following equation (a) was satisfied.

Fiber length of the reinforcing fiber (Pitch of blades)=reinforcing fiber strand width×tan(90-θ) (a)

(in which, θ represents an angle of a knife with respect to the circumferential direction.)

The pitch of blades was set to be 20 mm such that the reinforcing fibers were cut to be a fiber length of 20 mm.

The strand pieces which passed through the cutter were introduced into the flexible transport pipe arranged just below the rotary cutter, and then were introduced into an opening device (gas spray nozzle) continuously connected to the bottom of the transport pipe. As for an opening device, a double tube was manufactured by welding nipples made of SUS304 which have different diameters. Small holes were formed in the inner tube of the double tube such that compressed air was supplied by a compressor into a gap between the inner tube and the outer tube. Here, the wind velocity from the small holes was 450 m/sec. A tapered tube whose diameter was enlarging downward was welded at the bottom of the double tube so that the cut reinforcing fibers were moved downward through the inside of the tapered tube along with the flow of the air.

From the hole formed on a lateral surface of the tapered tube, a matrix resin was supplied into the tube. As the matrix resin, particles of a nylon resin (polyamide 6 resin) “A1030” which was manufactured by Unitika Limited were used.

Then, a breathable support (hereinafter, referred to as “a fixing net”) which was movable in a certain direction was provided below the outlet of the tapered tube, and suction from the bottom of the net was performed by a blower. A mixture of the particles of the nylon resin and the cut reinforcing fibers discharged from the distal end of the tapered tube together with the air flow was deposited in a band-shape onto the fixing net while the flexible transport pipe and the tapered tube were reciprocated in a width direction of the fixing net moving a constant velocity.

At this time, the supply amount of the reinforcing fibers was set to 212 g/min, the supply amount of the matrix resin was set to 320 g/min. A random mat in which the reinforcing fibers were spotlessly mixed with the thermoplastic resin was formed on the fixing net by operating the device. The fiber areal weight of the reinforcing fibers in the random mat was 265 g/m².

On the obtained random mat, when the ratio of the reinforcing fiber bundles (A), and the average number of fibers (N) were investigated, the critical single fiber number defined by equation (1) was 86, the ratio of the reinforcing fiber bundles (A) to the total amount of the reinforcing fibers in the mat was 35 Vol %, and the average number of fibers (N) in the reinforcing fiber bundles (A) was 240. Also, nylon resin particles were substantially spotlessly dispersed evenly in the reinforcing fibers.

Four sheets of the obtained random mat were layered, put in a mold, and press molded by heating at 300° C. and at a pressure of 1.0 MPa for 3 minutes so as to obtain a molded plate with a thickness of 2.0 mm. When the obtained molded plate of the composite material was subjected to an ultrasonic detection test, a non-impregnated section or a void was not detected.

Also, when tensile moduli in the directions of 0° and 90° of the obtained molded plate were measured, the ratio (Eδ) of moduli was 1.03. It was possible to obtain a molded plate in which a fiber orientation hardly occurred, and isotropy was maintained. Further, the molded plate was heated within a furnace at 500° C. for about 1 hour to remove the resin. When the ratio of the reinforcing fiber bundles (A) and the average number of fibers (N) were investigated, these measurement results were not different from those in the random mat.

### Example 2

As the reinforcing fiber, carbon fibers “TENAX” (trademark) STS40-24KS (average fiber diameter: 7 μm, strand width: 10 mm) manufactured by TOHO TENAX Co., Ltd were used. The fibers were slit with a width of 0.8 mm by using a vertical slit device and then cut to be a fiber length of 20 mm. As for a cut device, a rotary cutter was used in which spiral knives made of cemented carbide were arranged on the surface.

Here, the following equation (a) was satisfied.

Fiber length of the reinforcing fiber (Pitch of blades)=reinforcing fiber strand width×tan(90-θ) (a)

(in which, θ represents an angle of a knife with respect to the circumferential direction.)

The pitch of blades was set to be 20 mm such that the reinforcing fibers were cut to be a fiber length of 20 mm.

The strand pieces which passed through the cutter were introduced into the flexible transport pipe arranged just below the rotary cutter, and then were introduced into an opening device (gas spray nozzle). As for an opening device, as in Example 1, a double tube was manufactured by welding nipples made of SUS304 which have different diameters. Small holes were formed in the inner tube of the double tube such that compressed air was supplied into a gap between the inner tube and the outer tube. Here, the wind velocity from the small holes was changed with elapse of time from 100 m/sec to 450 m/sec at a rate of 100 m/sec for a minute. A tapered tube whose diameter was enlarging downward was welded at the bottom of the double tube.

From a lateral surface of the tapered tube, a matrix resin was supplied. As the matrix resin, particles of a nylon resin “A1030” which was manufactured by Unitika Limited were used. Then, a fixing net which was movable in a certain direction was provided below the outlet of the tapered tube, and suction from the bottom of the net was performed by a blower. A mixture of the particles of the nylon resin and the cut reinforcing fibers was deposited and fixed as a band-shape mat on the fixing net while the flexible transport pipe and the tapered tube were reciprocated in a width direction of the fixing net.

At this time, the supply amount of the reinforcing fibers was set to 212 g/min, the supply amount of the matrix resin was set to 320 g/min. A random mat with a thickness of about 6 mm in which the reinforcing fibers were mixed with the thermoplastic resin was formed on the fixing net by operating the device. The fiber areal weight of the reinforcing fibers in the random mat was 265 g/m².

On the obtained random mat, when the ratio of the reinforcing fiber bundles (A), and the average number of fibers (N) were investigated, the critical single fiber number defined by equation (1) was 86, and the reinforcing fiber bundles were gradually varied in the longitudinal direction of the mat in which the ratio of the reinforcing fiber bundles (A) to the total amount of the reinforcing fibers in the mat was changed from 35 Vol % to 80Vol %, and the average number of fibers (N) in the reinforcing fiber bundles (A) were changed 240 to 1000. Also, nylon resin particles were substantially spotlessly dispersed evenly in the reinforcing fibers.

Four sheets of the random mat were layered, charged up to 70% of the projection area of the mold, heated at a temperature of 300° C., at a pressure of 1.0 MPa, for heating time of 3 minutes, and then press molded by using a mold having a three-dimensional complex shape with a standing plane. The material of a portion having reinforcing fiber bundles in which the ratio of the reinforcing fiber bundles (A) to the total amount of the reinforcing fibers in the mat was 80 Vol %, and the average number of fibers (N) in the reinforcing fiber bundles (A) was 1000 flowed mainly on the standing plane so as to obtain a shaped article with a thickness of 2.0 mm and completely followed-up the mold shape. When the shaped article of the obtained composite material was subjected to an ultrasonic detection test, a non-impregnated section or a void was not detected.

Also, when tensile moduli in the directions of 0° and 90° of the obtained molded plate were measured, the ratio (Eδ) of moduli was 1.03. It was possible to obtain a molded plate in which a fiber orientation hardly occurred, and isotropy was maintained. Further, the molded plate was heated within a furnace at 500° C. for about 1 hour to remove the resin. When the ratio of the reinforcing fiber bundles (A) and the average number of fibers (N) were investigated, these measurement results were not different from those in the random mat.

### Example 3

As the reinforcing fiber, carbon fibers “TENAX” (trademark) STS40-24KS (average fiber diameter: 7 μm, strand width: 10 mm) manufactured by TOHO TENAX Co., Ltd were used. The fibers were slit with a width of 0.8 mm by using a vertical slit device and then cut to be a fiber length of 20 mm. As for a cut device, a rotary cutter was used in which spiral knives made of cemented carbide were arranged on the surface.

Here, the following equation (a) was satisfied.

Fiber length of the reinforcing fiber (Pitch of blades)=reinforcing fiber strand width×tan(90-θ) (a)

(in which, θ represents an angle of a knife with respect to the circumferential direction.)

The pitch of blades was set to be 20 mm such that the reinforcing fibers were cut to be a fiber length of 20 mm.

The strand pieces which passed through the cutter were introduced into the flexible transport pipe arranged just below the rotary cutter, and then were introduced into an opening device (gas spray nozzle). As for an opening device, as in Example 1, a double tube was manufactured by welding nipples made of SUS304 which have different diameters. Small holes were formed in the inner tube of the double tube such that compressed air was supplied into a gap between the inner tube and the outer tube. Here, the wind velocity from the small holes was 450 m/sec. A tapered tube whose diameter was enlarging downward was welded at the bottom of the double tube.

From the lateral surface of the tapered tube, a matrix resin was supplied. As the matrix resin, particles of a nylon resin “A1030” which was manufactured by Unitika Limited were used. Then, a fixing net which was movable in a certain direction was provided below the outlet of the tapered tube, and suction from the bottom of the net was performed by a blower. A mixture of the particles of the nylon resin and the cut reinforcing fibers was deposited and fixed as a band-shape mat on the fixing net while the flexible transport pipe and the tapered tube were reciprocated in a width direction of the fixing net.

At this time, the supply amount of the reinforcing fibers was set to 212 g/min, and the supply amount of the matrix resin was set to 547 g/min for a minute. After that, the device was operated after the supply amount of the matrix resin was changed to 320 g/min for a minute, and then changed to 205 g/min for a minute. A random mat in which the reinforcing fibers were mixed with the thermoplastic resin was formed on the support. The fiber areal weight of the reinforcing fibers in the random mat was 265 g/m².

On the obtained random mat, when the ratio of the reinforcing fiber bundles (A), and the average number of fibers (N) were investigated, the critical single fiber number defined by equation (1) was 86, the ratio of the reinforcing fiber bundles (A) to the total amount of the reinforcing fibers in the mat was 35 Vol %, and the average number of fibers (N) in the reinforcing fiber bundles (A) was 240, in which the ratio of the volume fraction of the reinforcing fibers to the total random mat was changed gradually from 20 Vol % to 40 Vol % in the longitudinal direction of the mat. Also, nylon resin particles were substantially spotlessly dispersed evenly in the reinforcing fibers.

Four sheets of the random mat were layered, charged up to 70% of the projection area of the mold, heated at a temperature of 300° C., at a pressure of 1.0 MPa, for heating time of 3 minutes, and then press molded by using a mold having a three-dimensional complex shape with a standing plane. As a result, to the area requiring strength, a portion in which the ratio of the reinforcing fibers to the entire random mat was 40 Vol % was allocated, and to the area not requiring strength, a portion in which the ratio of the reinforcing fibers to the entire random mat was 20 Vol % was allocated so as to obtain a shaped article with a thickness of 2.0 mm and completely followed-up the mold shape. The shaped article may provide a shaped product which satisfies the required structural properties, in particular strength and rigidity while reducing the use amount of the reinforcing fibers whose material cost is generally high. When the shaped product of the obtained composite material was subjected to an ultrasonic detection test, a non-impregnated section or a void was not detected.

When the tensile moduli in the directions of 0° and 90° of the obtained shaped article were measured in each of areas separated according to the reinforcing fiber volume fraction from 20 Vol % to 40 Vol %, the ratio (Eδ) of moduli was in a range from 1.03 to 1.05. It was possible to obtain a shaped article in which a fiber orientation hardly occurred, and isotropy was maintained. Further, the molded plate was heated within a furnace at 500° C. for about 1 hour to remove the resin. When the ratio of the reinforcing fiber bundles (A) and the average number of fibers (N) were investigated, these measurement results were not different from those in the random mat.

The heating was performed at 1.0 MPa for 3 minutes by using a press device heated to 300° C. to obtain a molded plate with a thickness of 0.6 mm. When the obtained composite material was subjected to an ultrasonic detection test, a non-impregnated section or a void was not detected.

### Example 4

As the reinforcing fiber, carbon fibers “TENAX” (trademark) STS40-24KS (average fiber diameter: 7 μm, strand width: 10 mm) manufactured by TOHO TENAX Co., Ltd were used. The fibers were slit with a width of 0.8 mm by using a vertical slit device and then cut to be a fiber length of 20 mm. As for a cut device, a rotary cutter was used in which spiral knives made of cemented carbide were arranged on the surface.

Here, the following equation (a) was satisfied.

Fiber length of the reinforcing fiber (Pitch of blades)=reinforcing fiber strand width×tan(90-θ) (a)

(in which, θ represents an angle of a knife with respect to the circumferential direction.)

The pitch of blades was set to be 20 mm such that the reinforcing fibers were cut to be a fiber length of 20 mm.

The strands pieces which passed through the cutter were introduced into the flexible transport pipe arranged just below the rotary cutter, and then were introduced into an opening device (gas spray nozzle). As for an opening device, as in Example 1, a double tube was manufactured by welding nipples made of SUS304 which have different diameters. Small holes were formed in the inner tube of the double tube such that compressed air was supplied into a gap between the inner tube and the outer tube. Here, the wind velocity from the small holes was 450 m/sec. A tapered tube whose diameter was enlarging downward was welded at the bottom of the tube.

From a lateral surface of the tapered tube, a matrix resin was supplied. As the matrix resin, particles of a nylon resin “A1030” which was manufactured by Unitika Limited were used. Then, a fixing net which is movable in a certain direction was provided below the outlet of the tapered tube, and suction from the bottom of the net was performed by a blower. A mixture of the particles of the nylon resin and the cut reinforcing fibers was deposited and fixed as a band-shape mat on the fixing net while the flexible transport pipe and the tapered tube were reciprocated in a width direction of the fixing net.

At this time, the moving speed of the fixing net which moves in a certain direction was set to 0.8 m/min, the supply amount of the reinforcing fibers was set to 634 g/min, the supply amount of the matrix resin was set to 958 g/min, and then the device was operated for a minute. After that, the moving speed of the fixing net was changed to 1.0 m/min, the supply amount of the reinforcing fibers was changed to 528 g/min, the supply amount of the matrix resin was set to 798 g/min, and then the device was operated continuously for 1 min. The moving speed of the fixing net was changed to 1.5 m/min, the supply amount of the reinforcing fibers was changed to 396 g/min, the supply amount of the matrix resin was set to 599 g/min, and then the device was operated continuously to form a random mat in which the reinforcing fibers were mixed with the thermoplastic resin, on the fixing net. The fiber areal weight of the reinforcing fibers in the random mat was 792 g/m² when the moving speed of the fixing net was 0.8 m/min, 528 g/m² when the moving speed was 1.0 m/min, and 264 g/m² when the moving speed was 1.5 m/min.

On the obtained random mat, when the ratio of the reinforcing fiber bundles (A), and the average number of fibers (N) were investigated, the critical single fiber number defined by equation (1) was 86, the ratio of the reinforcing fiber bundles (A) to the total amount of the reinforcing fibers in the mat was 35 Vol %, and the average number of fibers (N) in the reinforcing fiber bundles (A) was 240. Also, nylon resin particles were substantially spotlessly dispersed evenly in the reinforcing fibers.

Four sheets of the obtained random mat were layered in a direction their upstream sides and downstream sides were matched, heated at a temperature of 300° C., at a pressure of 1.0 MPa, for heating time of 3 minutes, and then press molded by using a three-dimensional complex shaped mold having an inclined plane. As a result, a shaped product with a thickness continuously inclined from 2 mm to 6 mm and a complete mold shape follow-up property was obtained. When the shaped product of the composite material was subjected to an ultrasonic detection test, a non-impregnated section or a void was not detected.

When the tensile moduli in the directions of 0° and 90° of the obtained molded plate were measured in each of areas separated according to the volume fraction of reinforcing fibers from 20 Vol % to 40 Vol %, the ratio (Eδ) of moduli was 1.02. It was possible to obtain a molded plate in which fiber orientation hardly occurred, and isotropy was maintained. Further, the molded plate was heated within a furnace at 500° C. for about 1 hour to remove the resin. When the ratio of the reinforcing fiber bundles (A) and the average number of fibers (N) were investigated, these measurement results were not different from those in the random mat.

The random mat was heated at 1.0 MPa for 3 minutes by using a press device heated to 300° C. to obtain a molded plate with a thickness of 0.6 mm. When the obtained composite material was subjected to an ultrasonic detection test, a non-impregnated section or a void was not detected.

### Example 5

As the reinforcing fiber, carbon fibers “TENAX” (trademark) STS40-24KS (average fiber diameter: 7 μm, strand width: 10 mm) manufactured by TOHO TENAX Co., Ltd were used. The fibers were slit with a width of 0.8 mm by using a vertical slit device and then cut to be a fiber length of 20 mm. As for a cut device, a rotary cutter was used in which spiral knives made of cemented carbide were arranged on the surface.

Here, the following equation (a) was satisfied.

Fiber length of the reinforcing fiber (Pitch of blades)=reinforcing fiber strand width×tan(90-θ) (a)

(in which, θ represents an angle of a knife with respect to the circumferential direction.)

The pitch of blades was set to be 20 mm such that the reinforcing fibers were cut to be a fiber length of 20 mm.

The strands pieces which passed through the cutter were introduced into the flexible transport pipe arranged just below the rotary cutter, and then were introduced into an opening device (gas spray nozzle). As for an opening device, as in Example 1, a double tube was manufactured by welding nipples made of SUS304 which have different diameters. Small holes were formed in the inner tube of the double tube such that compressed air was supplied by a compressor into a gap between the inner tube and the outer tube. Here, the wind velocity from the small holes was 450 msec. A tapered tube whose diameter was enlarging downward was welded at the bottom of the double tube.

From a lateral surface of the tapered tube, a matrix resin was supplied. As the matrix resin, particles of a nylon resin “A1030” which was manufactured by Unitika Limited were used. The supply amount of the reinforcing fibers was set to 137 g/min, and the supply amount of the matrix resin was set to 207 g/min. A fixing net which was movable in a certain direction was provided below the outlet of the tapered tube, and suction from the bottom of the net was performed by a blower. A mixture of the nylon resin and the cut reinforcing fibers was deposited and fixed as a band-shaped mat on the fixing net while the flexible transport pipe and the tapered tube were reciprocated in a width direction of the fixing net. At this time, a random mat having a tapered shape was formed on the fixing net by changing continuously the moving distance of the tapered tube from 1.0 m to 0.3 m in a width direction of the fixing net, in which in the random mat, the reinforcing fibers were spotlessly mixed with the thermoplastic resin. The fiber areal weight of the reinforcing fibers in the random mat was 265 g/m².

On the obtained random mat, when the ratio of the reinforcing fiber bundles (A), and the average number of fibers (N) were investigated, the critical single fiber number defined by equation (1) was 86, the ratio of the reinforcing fiber bundles (A) to the total amount of the reinforcing fibers in the mat was 35 Vol %, and the average number of fibers (N) in the reinforcing fiber bundles (A) was 240. Also, nylon resin particles were substantially spotlessly dispersed evenly in the reinforcing fibers.

Four sheets of the obtained random mat were layered, heated at a temperature of 300° C., at a pressure of 1.0 MPa, for heating time of 3 minutes, and then press molded by using a three-dimensional complex shaped mold having a tapered shape so as to obtain a shaped product with a completely followed-up mold shape and a thickness of 2 mm. When obtaining the shaped product, because the random mat itself was introduced in a shape close to the final shape into the mold, offcuts of the material were not necessary and thus the manufacturing efficiency could be increased. When the shaped product of the obtained composite material was subjected to an ultrasonic detection test, a non-impregnated section or a void was not detected.

When the tensile moduli in the directions of 0° and 90° of the obtained shaped product were measured in each of areas separated according to the volume fraction of reinforcing fibers from 20 Vol % to 40 Vol %, the ratio (Eδ) of moduli was 1.04. It was possible to obtain a molded plate in which a fiber orientation hardly occurred, and isotropy was maintained. Further, the molded plate was heated within a furnace at 500° C. for about 1 hour to remove the resin. When the ratio of the reinforcing fiber bundles (A) and the average number of fibers (N) were investigated, these measurement results were not different from those in the random mat.

### Example 6

As the reinforcing fiber, carbon fibers “TENAX” (trademark) IMS60-12KS (average fiber diameter: 5 μm, fiber width: 6 mm) manufactured by TOHO TENAX Co., Ltd were used. The fibers were slit with a width of about 0.8 mm and then cut to be a fiber length of 20 mm. As for a cut device, a rotary cutter was used in which spiral knives made of cemented carbide were arranged on the surface. On the rotary cutter, the blades parallel to the fiber direction were provided at the intervals of 0.5 mm. Here, in the formula (a), θ was 17°, and the pitch of blades was 20 mm. The cut reinforcing fibers were immediately introduced into an opening device arranged just below the rotary cutter to be opened by gas spray. As for an opening device, as in Example 1, a double tube having small holes inside was used, and compressed air was supplied thereto. Here, the wind velocity from the small holes was 150 m/sec. A tapered tube was welded at the bottom of the double tube.

From a lateral surface of the tapered tube, as a matrix resin, polyamide 66 fibers (“T5 nylon” which was manufactured by Asahi Kasei Fibers Corporation, fineness: 1400 dtex) dry cut into 2 mm were supplied. A breathable table capable of moving in XY directions was provided below the outlet of the tapered tube, and suction from the bottom of the table was performed by a blower. After the supply amount of the reinforcing fibers was set to 1,000 g/min, and the supply amount of the matrix resin was set to 3,000 g/min, the device was operated to obtain a random mat with a thickness of about 10 mm including the reinforcing fibers mixed with the polyamide short fibers. The fiber areal weight of the reinforcing fibers in the random mat was 1,000 g/m².

On the obtained random mat, when the ratio of the reinforcing fiber bundles (A), and the average number of fibers (N) were investigated, the critical single fiber number defined by equation (1) was 120, the ratio of the reinforcing fiber bundles (A) to the total amount of reinforcing fibers of the mat was 86%, and the average number of fibers (N) in the reinforcing fiber bundles (A) was 900. Also, polyamide fibers were substantially spotlessly dispersed in the reinforcing fibers.

The obtained random mat was heated and pressed by using a heated nip roller at 280° C., and polyamide fibers in the mat were molten to be impregnated into the reinforcing fibers over the mat and cooled to obtain a composite material sheet.

This was heated at 1.0 MPa for 3 minutes by using a heated press molding device to obtain a molded plate with a thickness of 3.2 mm. When the molded plate of the obtained composite material was subjected to an ultrasonic detection test, a non-impregnated section or a void was not detected.

Also, when tensile moduli in the directions of 0° and 90° of the obtained molded plate were measured, the ratio (Eδ) of moduli was 1.07. It was possible to obtain a material in which a fiber orientation hardly occurred, and isotropy was maintained. Further, the molded plate was heated within a furnace at 500° C. for about 1 hour to remove the resin. When the ratio of the reinforcing fiber bundles (A) and the average number of fibers (N) were investigated, these measurement results were not different from those in the random mat.

### REFERENCE SIGNS LIST

11: creel
12: widening device
13: fiber leading guide 13
14: cutting and opening device
15: the supplying unit of the thermoplastic resin
16: breathable support (the conveyor provided with a breathable net)
17: suction device
18: preheating apparatus of the random mat
19: vertical slit device
Y: strand including reinforcing fibers
M: random mat

While the present invention has been shown and described with reference to certain exemplary embodiments thereof, it will be understood by those skilled in the art that various changes modifications may be made therein without departing from the spirit and scope of the present invention as defined by the appended claims.

What is claimed is:

1. A method of producing a random mat for manufacturing a thermoplastic composite material, comprising:
slitting continuously a strand including reinforcing fibers in a longitudinal direction of the strand to form a plurality of reinforcing fiber strands with narrow width;
cutting the reinforcing fiber strands with narrow width continuously to be an average fiber length of 3 mm to 100 mm to form reinforcing fiber strand pieces;
spraying gas onto the cut reinforcing fiber strand pieces for opening the reinforcing fiber strand pieces to form reinforcing fiber bundle pieces; and
depositing and fixing the reinforcing fiber bundle pieces onto a breathable support together with a thermoplastic resin in a powder or short fibrous form to form an isotropic random mat in which the reinforcing fibers and the thermoplastic resin are mixed.

2. The method according to claim 1,
wherein the strands with narrow width is 0.05 mm to 5 mm.

3. The method according to claim 1,
wherein the breathable support is movable.

4. The method according to claim 1,
wherein the reinforcing fibers are carbon fibers.

5. The method according to claim 1,
wherein the isotropic random mat including:
reinforcing fiber bundles (A) having single reinforcing fibers of a critical single fiber number or more, being defined by equation (1); and
at least one of reinforcing fiber bundles (B1) having single reinforcing fibers of less than the critical single fiber number and single reinforcing fibers (B2):
Critical single fiber number=600/D (1)
wherein D represents an average fiber diameter (μm) of the single reinforcing fibers.

6. The method according to claim 5,
wherein a ratio of the reinforcing fiber bundles (A) to a total amount of the reinforcing fibers in the isotropic random mat ranges from 20 Vol % to 99 Vol %.

7. The method according to claim 5,
wherein the average number of fibers (N) in the reinforcing fiber bundles (A) in the isotropic random mat satisfies equation (2):
0.7×10⁴/D²<N<6×10⁴/D² (2)
wherein D represents an average fiber diameter (μm) of the single reinforcing fibers.

8. The method according to claim 1,
wherein the reinforcing fiber strand pieces are suctioned and conveyed in a transport path,
the gas is sprayed onto the reinforcing fiber strand pieces from a gas spray nozzle arranged in a way of the transport path or at a distal end of the transport path,
the thermoplastic resin in the powder or short fibrous form is supplied from a way of the transport path or at the distal end of the transport path, and
the breathable support is movable in a specific direction.

9. The method according to claim 8,
wherein the transport path includes a flexible tube, and
a tapered tube is connected to a distal end of the flexible tube to spread the reinforcing fibers and the thermoplastic resin in the tapered tube.

10. The method according to claim 8,
wherein an outlet of the transport path, which discharges the reinforcing fibers and the thermoplastic resin is reciprocated in a horizontal direction, which is perpendicular to the specific direction, to form the isotropic random mat with a specific width, the isotropic random mat including the reinforcing fibers and the thermoplastic resin in a mixed state, on the breathable support.

11. The method according to claim 8,
wherein the ratio of the reinforcing fiber bundles (A) to the total amount of the reinforcing fibers in the random mat and the average number (N) of fibers in the reinforcing fiber bundles are freely changed by adjusting a spraying pressure of an air flow to the cut reinforcing fiber strand pieces to manufacture the isotropic random mat with various physical properties.

12. The method according to claim 8,
wherein a supply amount of the thermoplastic resin to the outlet of the transport path is changed with elapse of time such that a volume fraction of the reinforcing fibers in the isotropic random mat is partially varied.

13. The method according to claim 3,
wherein a moving speed of the breathable support and a speed of the reciprocating motion of the outlet of the transport path are changed, respectively, with elapse of time such that a fiber areal weight of the isotropic random mat is continuously varied or a thickness of the isotropic random mat is inclined.

14. The method according to claim 8,
wherein the outlet of the transport path is reciprocated in a horizontal direction, which is perpendicular to the specific direction, and
a reciprocation distance is continuously changed to manufacture the isotropic random mat in which a width of the random mat is varied along a longitudinal direction of the random mat.
